(19) United States
(12) Patent Application Publication
(10) Pub. No.: US 2013/0105533 A1
(43) Pub. Date: May 2, 2013

(54) FRONT OF SEAT ORGANIZER

(71) Applicant: Ralph Orduno, Las Vegas, NV (US)

(72) Inventor: Ralph Orduno, Las Vegas, NV (US)

(21) Appl. No.: 13/665,783

(22) Filed: Oct. 31, 2012

Related U.S. Application Data
(60) Provisional application No. 61/553,408, filed on Oct. 31, 2011.

(51) Int. Cl. B60R 7/04

(52) U.S. Cl. 224/275

(57) ABSTRACT

A system for organizing items. The system includes a body configured to attach to the front of a seat and a pocket. The pocket is attached to the body and configured to hold a first item. The system also includes a set of pockets. The set of pockets is attached to the body via the first pocket and configured to hold a second item.

### CROSS-REFERENCE TO RELATED APPLICATIONS

This application claims the benefit of and priority to U.S. Provisional Patent Application Ser. No. 61/553,408 filed on Oct. 31, 2011, which application is incorporated herein by reference in its entirety.

### BACKGROUND OF THE INVENTION

People tend to spend a lot time in their cars while taking road trips or just commuting to work daily. Cars are designed with many compartments and slots so that people have a place to put all the stuff they need while away from home. However, many of those places are not easy for a driver to reach, such as the glove compartment. A user's sun visor is within easy reach, but placing an item there may make it impossible to use the visor for its intended purpose, which may be dangerous.

Also, many people often keep smaller items like pens, paperclips, keys and loose change in their cup holders in order to keep everything in one place. But then a user may not have a spot to put a drink while in the car, which may force the driver to take his or her eyes off the road, which may lead to a spilled drink or worse: an accident with another vehicle. An effective solution is necessary.

Accordingly, there is a need in the art for a system that provides drivers with a way to keep all of their important things at their fingertips. Further, there is a need in the art for the system to not take up much room in the car and may contain pockets that can hold large items like an 8½″ by 11″ document along with smaller pouches suitable for electronic devices, pens and notebooks. Additionally, there is a need in the art for the system to allow a user once he/she puts his/her items into a chosen pocket to retrieve the objects without the driver taking his or her eyes off the road.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for organizing items. The system includes a body configured to attach to the front of a seat and a pocket. The pocket is attached to the body and configured to hold a first item. The system also includes a set of pockets. The set of pockets is attached to the body via the first pocket and configured to hold a second item.

Another example embodiment includes a system for organizing items. The system includes a body and a pocket. The pocket is attached to the body and configured to hold a first item. The system also includes a set of pockets. The set of pockets is attached to the body via the first pocket and configured to hold a second item. The system further includes an attachment, wherein the attachment is configured to secure the body to front of a seat.

Another example embodiment includes a system for organizing items. The system includes a body. The system also includes a stabilizer within the body configured to provide structure to the body. The system further includes a pocket. The pocket is attached to the body and configured to hold a first item. The system additionally includes a set of pockets. The set of pockets is attached to the body via the first pocket and configured to hold a second item. The system moreover includes an attachment, wherein the attachment is configured to secure the body to the front of a seat.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top front perspective view of the example of the front seat organizer;

FIG. 1B illustrates a top view of the example of the front seat organizer; and

FIG. 2 illustrates a cutaway view of the front seat organizer.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

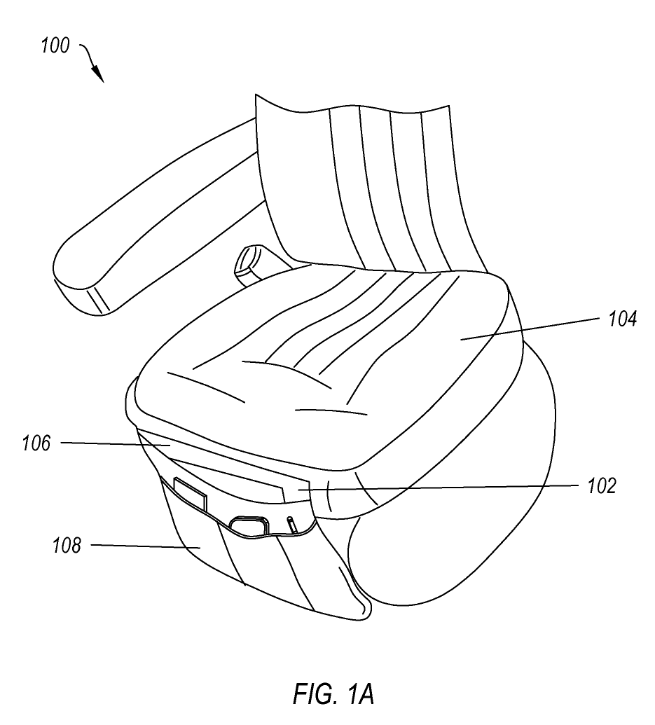

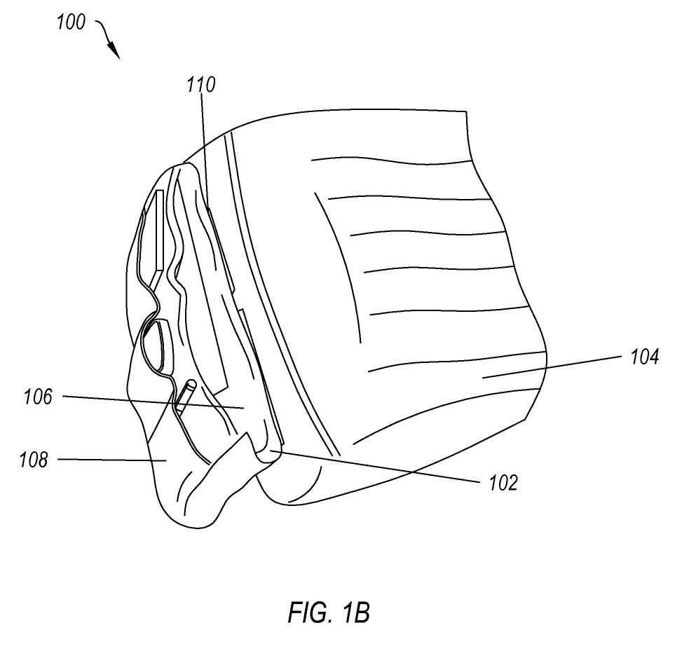

FIGS. 1A and 1B illustrate an example of a front seat organizer 100. FIG. 1A illustrates a top front perspective view of the example of the front seat organizer; and FIG. 1B illustrates a top view of the example of the front seat organizer. The front seat organizer can allow a user to place items, such as a wallet, glasses, cell phone, paper, pen or other desired items near the front of a seat in a car or other locations. The front seat organizer 100 can be sufficiently thin to prevent it from causing the user discomfort. I.e., the front seat organizer 100 can be attached to the seat without causing the user to move or adjust position in order to be of use.

FIGS. 1A and 1B show that the front seat organizer 100 can include a body 102. The body 102 can be configured to support the remainder of the front seat organizer 100. I.e., the body 102 can form the main part of the front seat organizer 100 which allows it to be placed in the correct position and which provides sufficient structure to the rest of the front seat organizer 100 to remain in the desired position. For example, the body 102 can be between 10 inches and 14 inches wide and between 5 inches and 7 inches tall. E.g., the body 102 can be approximately 12 inches wide and 6 inches tall. The dimensions of the body 102 can be critical to allow the body 102 to be attached to a seat 104, as described below. As used in the specification and the claims, the term approximately shall mean that the value is within 10% of the stated value, unless otherwise specified.

FIGS. 1A and 1B show that the front seat organizer 100 can include a pocket 106. The pocket 106 can be approximately the same width as the body 102. That is, the pocket 106 can be nearly as wide as the body 102. The pocket 106 can allow the user to place large objects within the front seat organizer 100. I.e., the pocket 106 can provide as much space as possible within the limits imposed by the body 102.

FIGS. 1A and 1B also show that the front seat organizer 100 can include a set of pockets 108. The set of pockets 108 can include pockets that are specialized to hold particular items. For example, the set of pockets 108 can include pockets sized to accommodate a cell phone, a pen, a tablet computer, an iPod, a notebook, a wallet, personal items or any other desired materials.

FIGS. 1A and 1B further show that the front seat organizer 100 can include an attachment 110. The attachment 110 can be configured to attach the front seat organizer 100 to the front of a seat. For example, the attachment 110 can include a hook and loop fastener, a strap, an elastic cord, upholstery pins or any other desired attachment. E.g., the attachment 110 can include a hook and loop fastener that is between 10 inches and 14 inches wide and between 1 inch and 3 inches tall. For example, the attachment 110 can include a hook and loop fastener that is approximately 12 inches wide and 2 inches tall. The dimensions of the hook and loop fastener as disclosed herein can be critical to ensure that the hook and loop fastener can secure the front seat organizer 100 to the desired seat.

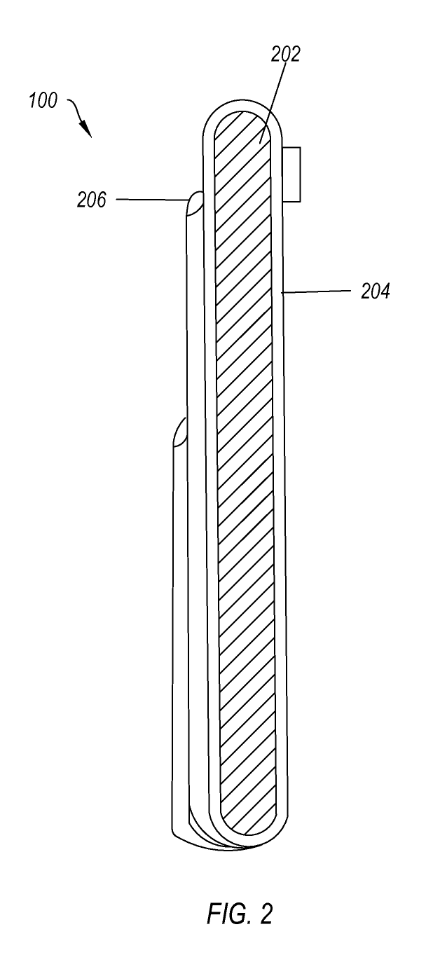

FIG. 2 illustrates a cutaway view of the front seat organizer 100. The front seat organizer 100 can remain in place without substantially interfering with the user sitting in the seat. For example, the front seat organizer 100 can be attached to a seat in a car, a wheelchair, a home or any other desired seat.

FIG. 2 shows that the front seat organizer 100 can include a stabilizer 202. The stabilizer 202 can include any material configured to provide structure to the body 102. I.e., the stabilizer 202 can include a material which allows the body 102 to retain its shape. For example, the stabilizer 202 can include peltex, cardboard, Styrofoam or any other desired material. Peltex is a polyester material which can for a sturdy but flexible material.

FIG. 2 also shows that the body 102 can include an outer covering 204. For example the outer covering 204 can include vinyl, leather, cloth, or any other desired material. The outer cover 204 can be placed around the stabilizer 204. I.e., the outer covering 204 can be the surface that the user “interacts” with. The outer covering 204 can be colored based on user preferences. I.e., the outer covering 204 can have a variety of colors. One of skill in the art will appreciate that the outer covering 204 can likewise be used to form the pocket 104 and the set of pockets 106 or that different material can be attached to the outer covering 204 to form the pocket 104 and the set of pockets 106.

FIG. 2 further shows that the front seat organizer 100 can include a closure mechanism 206. The closure mechanism 206 can include a device that is configured to automatically close the pocket 104 or any of the pockets within the set of pockets 106. For example, the closure mechanism 206 can include an elastic strap or some other device configured to hold the pocket 104 or any of the pockets within the set of pockets 106.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for organizing items, the system comprising:
a body configured to attach to the front of a seat;
a pocket:
attached to the body; and
configured to hold a first item; and
a set of pockets:
attached to the body via the first pocket; and
configured to hold a second item.

2. The system of claim 1, wherein the first item includes:
a mobile phone.

3. The system of claim 1, wherein the first item includes:
a notebook.

4. The system of claim 1, wherein the first item includes:
a laptop computer.

5. The system of claim 1, wherein the first item includes:
a tablet computer.

6. The system of claim 1, wherein the first item includes:
an mp3 player.

7. A system for organizing items, the system comprising:
a body;
a pocket:
attached to the body; and
configured to hold a first item;
a set of pockets:
attached to the body; and
configured to hold a second item; and
an attachment, wherein the attachment is configured to secure the body to the front of a seat.

8. The system of claim 7, wherein the seat includes the seat in a car.

9. The system of claim 7, wherein the pocket is approximately the same width as the body.

10. The system of claim 7, wherein the body is between 10 inches wide and 14 inches wide.

11. The system of claim 10, wherein the body is approximately 12 inches wide.

12. The system of claim 7, wherein the body is between 5 inches tall and 7 inches tall.

13. The system of claim 12, wherein the body is approximately 6 inches tall.

14. The system of claim 10, wherein the attachment includes a hook and loop fastener.

15. The system of claim 14, wherein the hook and loop fastener is between 10 inches wide and 14 inches wide.

16. The system of claim 15, wherein the hook and loop fastener is approximately 12 inches wide.

17. The system of claim 7, wherein the hook and loop fastener is between 1 inch tall and 3 inches tall.

18. The system of claim 17, wherein the hook and loop fastener is approximately 2 inches tall.

19. A system for organizing items, the system comprising:
a body configured to attach to the front of a seat;
a stabilizer within the body configured to provide structure to the body;
a pocket:
attached to the body; and
configured to hold a first item;
a set of pockets:
attached to the body; and
configured to hold a second item; and
an attachment, wherein the attachment is configured to secure the body to a seat.

20. The system of claim 19, wherein the stabilizer include Peltex.
